(19) United States
(12) Patent Application Publication
(10) Pub. No.: US 2015/0137639 A1
(43) Pub. Date: May 21, 2015

(54) MOTOR

(71) Applicants: NIDEC SANKYO CORPORATION, Suwagun (JP); Nidec Sankyo Electronics (Dongguan) Corporation, Dongguan (CN)

(72) Inventors: Masato GOMYO, Dongguan (CN); Zhan Wen CHEN, Dongguan (CN)

(21) Appl. No.: 14/540,572

(22) Filed: Nov. 13, 2014

(30) Foreign Application Priority Data
Nov. 15, 2013 (CN) 201310573709.6

(51) Int. Cl. H02K 3/52; H02K 5/22; H02K 1/27

(52) U.S. Cl. CPC H02K 3/522; H02K 1/2753; H02K 5/225
USPC 310/71; 310/208

(57) ABSTRACT

A motor may include a rotor having a magnet and a stator having a stator core and a coil. The stator core is provided with salient poles, including a predetermined salient pole, separately formed in the circumferential direction, the salient poles are protruded to an inner side and face the magnet through a gap space, and the predetermined salient pole is wound around with the coil through a coil bobbin. The stator core is provided with a connecting part which connects end parts of the salient poles. The coil bobbin is provided with a body part around which the coil is wound and an insertion hole formed in the body part and into which the predetermined salient pole is inserted. The coil bobbin and the stator core engage with the other to restrain displacement of the coil bobbin to the inner side.

### CROSS REFERENCE TO RELATED APPLICATION

The present invention claims priority under 35 U.S.C. §119 to Chinese Application No. 201310573709.6 filed Nov. 15, 2013, the entire content of which is incorporated herein by reference.

### FIELD OF THE INVENTION

At least an embodiment of the present invention may relate to a motor in which a coil is wound around a predetermined salient pole of a plurality of salient poles of a stator core provided along a peripheral face of a magnet.

### BACKGROUND

In a meter device for a vehicle or a display device such as a clock, a pointer may be attached to an output shaft of a motor. As a motor which is used in the display device, as shown in FIG. 28, a technique has been proposed in which a stator core “CA” is provided with a plurality of salient poles in a circumferential direction and two salient poles “p1” and “p2” of a plurality of the salient poles are attached with coil bobbins “CB” around which a coil is wound (see Japanese Patent Laid-Open No. 2013-57567). In the motor described in the Patent Literature, as shown in FIG. 28, an attaching hole into which a salient pole of the stator core is inserted is formed in the coil bobbin “CB” around which a coil is wound, and the coil bobbin is attached to the stator core by inserting the salient pole of the stator core into the attaching hole.

In the motor described above, when the coil bobbin “CB” is to be attached to the stator core “CA”, only the salient poles “p1” and “p2” of the stator core “CA” are inserted into the attaching holes of the coil bobbin “CB” and thus, during assembling of the motor, an attaching position of the coil bobbin “CB” to the stator core “CA” is easily displaced due to vibration or the like and an end part of the coil bobbin may be easily protruded toward an inner side in a radial direction of the stator core where the rotor is attached. Therefore, when a rotor whose peripheral face is provided with a magnet is to be assembled with respect to the stator core assembled with the coil bobbins, the magnet of the rotor is easily contacted with the coil bobbin.

### SUMMARY

In view of the problem described above, at least an embodiment of the present invention may advantageously provide a motor which is capable of restraining displacement of the coil bobbin attached to the stator core to an inner side in the radial direction of the stator core.

According to at least an embodiment of the present invention, there may be provided a motor including a rotor having a magnet whose peripheral face is alternately magnetized in an “S”-pole and an “N”-pole in a circumferential direction, and a stator having a stator core and a coil. The stator core is provided with a plurality of salient poles including a predetermined salient pole which are separately formed in the circumferential direction, the plurality of the salient poles is protruded to an inner side in a radial direction and faces the peripheral face of the magnet through a gap space, and the predetermined salient pole is wound around with the coil through a coil bobbin. In the motor, the stator core is provided with a connecting part which connects end parts on an outer side in the radial direction of the plurality of the salient poles, and the coil bobbin is provided with a body part around which the coil is wound and a salient pole insertion hole which is formed in the body part and into which the predetermined salient pole is inserted. In addition, one of the coil bobbin and the stator core is formed with an engaging part which is engaged with the other of the coil bobbin and the stator core to restrain displacement of the coil bobbin to the inner side in the radial direction.

According to the motor in accordance with at least an embodiment of the present invention, one of the coil bobbin and the stator core is formed with an engaging part which is engaged with the other of the coil bobbin and the stator core so as to restrain displacement of the coil bobbin to the inner side in the radial direction. Therefore, the coil bobbin attached to the stator core is restrained from moving to an inner side in the radial direction of the stator core. Accordingly, when a motor is to be assembled, a possibility is reduced that the coil bobbin is protruded to an inner side in the radial direction of the stator core relative to an inner side end part in the radial direction of the predetermined salient pole of the stator core due to vibration or the like. As a result, a possibility that the magnet provided in the peripheral face of the rotor is abutted with the coil bobbin and insertion of the rotor is prevented by the coil bobbin is reduced, and thus assembling efficiency of the motor can be improved.

In the motor in accordance with at least an embodiment of the present invention, the engaging part includes a protruded engaging part which is formed in the coil bobbin, and the protruded engaging part is protruded to an outer side in the radial direction relative to the body part of the coil bobbin to engage with the connecting part of the stator core. According to this structure, the coil bobbin attached to the stator core is restrained from moving to the inner side in the radial direction of the stator core with a simple structure. Therefore, a possibility that the magnet provided in the peripheral face of the rotor is abutted with the coil bobbin and insertion of the rotor is prevented by the coil bobbin is reduced, and thus assembling efficiency of the motor can be improved.

In this case, it is preferable that the connecting part is locked between the protruded engaging part and the body part. According to this structure, the coil bobbin attached to the stator core is effectively restrained from moving to the inner side in the radial direction of the stator core and assembling efficiency of the motor can be further improved.

In the motor in accordance with at least an embodiment of the present invention, the coil bobbin is provided with a flange part on the outer side in the radial direction of the body part, and the protruded engaging part is protruded from the flange part to the outer side in the radial direction to engage with the connecting part of the stator core. According to this structure, the coil bobbin attached to the stator core is restrained from moving to the inner side in the radial direction of the stator core with a simple structure. Therefore, a possibility is reduced that the magnet provided in the peripheral face of the rotor is abutted with the coil bobbin and insertion of the rotor is prevented by the coil bobbin, and thus assembling efficiency of the motor can be improved.

In this case, it is preferable that the connecting part is locked between the protruded engaging part and the flange part. According to this structure, the coil bobbin attached to the stator core is effectively restrained from moving to the inner side in the radial direction of the stator core and assembling efficiency of the motor can be further improved.

In the motor in accordance with at least an embodiment of the present invention, the protruded engaging part is provided with an arm part, which protrudes to the outer side in the radial direction relative to the body part, and an engaging tip end part which is bent toward a connecting part side from a tip end of the arm part to engage with the connecting part. According to this structure, the coil bobbin attached to the stator core is restrained from moving to the inner side in the radial direction of the stator core with a simple structure. Therefore, a possibility is reduced that the magnet provided in the peripheral face of the rotor is abutted with the coil bobbin and insertion of the rotor is prevented by the coil bobbin, and thus assembling efficiency of the motor can be improved.

In this case, it is preferable that an outer side face of the engaging tip end part in the radial direction is formed as an inclined face which is inclined with respect to the radial direction, and the inclined face is directed to a side where the stator core is located in an axial direction of the rotor. According to this structure, the inclined face functions as a guide when the coil bobbin is to be attached to the predetermined salient pole. Therefore, the coil bobbin can be easily attached to the salient pole and thus assembling efficiency of the motor can be improved.

In the motor in accordance with at least an embodiment of the present invention, the coil bobbin is provided with a flange part on the outer side in the radial direction of the body part, and the flange part is interposed between a portion of the connecting part located on a side with respect to the predetermined salient pole in the circumferential direction and a portion of the connecting part located on the outer side in the radial direction of the flange part. According to this structure, the coil bobbin attached to the stator core is restrained from moving to the inner side in the radial direction of the stator core with a simple structure. Therefore, a possibility is reduced that the magnet provided in the peripheral face of the rotor is abutted with the coil bobbin and insertion of the rotor is prevented by the coil bobbin, and thus assembling efficiency of the motor can be improved.

In the motor in accordance with at least an embodiment of the present invention, in a case that the coil bobbin is provided with a flange part on the outer side in the radial direction relative to the body part, the engaging part is provided with a first protruded part formed on a portion of the connecting part located on a side with respect to the predetermined salient pole in the circumferential direction, and the flange part is interposed between a portion of the connecting part located on the outer side in the radial direction relative to the flange part and the first protruded part. According to this structure, the coil bobbin attached to the stator core is restrained from moving to the inner side in the radial direction of the stator core with a simple structure. Therefore, a possibility is reduced that the magnet provided in the peripheral face of the rotor is abutted with the coil bobbin and thereby insertion of the rotor is prevented by the coil bobbin, and thus assembling efficiency of the motor can be improved.

In this case, it is preferable that the flange part is locked between the portion of the connecting part located on the outer side in the radial direction relative to the flange part and the first protruded part. According to this structure, the coil bobbin attached to the stator core is further effectively restrained from moving to the inner side in the radial direction of the stator core and assembling efficiency of the motor can be further improved.

In the motor in accordance with at least an embodiment of the present invention, the engaging part includes a second protruded part which is formed on one of an outer peripheral face of the predetermined salient pole and an inner wall face of a salient pole insertion hole of the body part, and the second protruded part is engaged with the other of the outer peripheral face of the predetermined salient pole and the inner wall face of the salient pole insertion hole of the body part. According to this structure, the coil bobbin attached to the stator core is restrained from moving to the inner side in the radial direction of the stator core with a simple structure. Therefore, a possibility is reduced that the magnet provided in the peripheral face of the rotor is abutted with the coil bobbin and thereby insertion of the rotor is prevented by the coil bobbin, and thus assembling efficiency of the motor can be improved.

In this case, it is preferable that the second protruded part is formed at a position which is near to the magnet. Further, it is preferable that the second protruded part is extended along the radial direction. According to this structure, the coil bobbin attached to the stator core is restrained from moving to the inner side in the radial direction of the stator core. Therefore, a possibility that the magnet provided in the peripheral face of the rotor is abutted with the coil bobbin and thereby insertion of the rotor is prevented by the coil bobbin is reduced, and thus assembling efficiency of the motor can be improved.

In the motor in accordance with at least an embodiment of the present invention, the engaging part includes a recessed part which is formed on the other of the outer peripheral face of the predetermined salient pole and the inner wall face of the salient pole insertion hole so as to engage with the second protruded part. According to this structure, the coil bobbin attached to the stator core is restrained from moving to the inner side in the radial direction of the stator core with a simple structure. Therefore, a possibility that the magnet provided in the peripheral face of the rotor is abutted with the coil bobbin and thereby insertion of the rotor is prevented by the coil bobbin is reduced, and thus assembling efficiency of the motor can be improved.

In this case, it is preferable that the inner wall face of the salient pole insertion hole is formed with the protruded part, and the outer peripheral face of the predetermined salient pole is formed with the recessed part. In this case, it is preferable that the protruded part and the recessed part are formed at positions which are near to the magnet. Further, it is preferable that the protruded part and the recessed part are extended along the radial direction. In this case, it is preferable that the protruded part and the recessed part are formed so as to extend continuously along the radial direction or formed at plural positions in the radial direction in a separated manner. According to this structure, the coil bobbin attached to the stator core is restrained from moving to the inner side in the radial direction of the stator core with a simple structure. Therefore, a possibility is reduced that the magnet provided in the peripheral face of the rotor is abutted with the coil bobbin and thereby insertion of the rotor is prevented by the coil bobbin, and thus assembling efficiency of the motor can be improved.

In the motor in accordance with at least an embodiment of the present invention, the coil bobbin is formed with a terminal fixed part to which a terminal is fixed, and an end part of a winding of the coil is wound around the terminal. In this case, it may be structured that the motor includes a case, the rotor and the stator are accommodated in the case, and the terminal is protruded to an outside of the case through a through hole provided in the case. According to this structure, the coil bobbin and the stator core are engaged with each other by the engaging part and thereby the coil bobbin attached to the stator core is restrained from moving to the inner side in the radial direction of the stator core and the position of the terminal can be stabilized. Therefore, after the stator, the rotor and the like have been assembled within the case of the motor, another case can be assembled easily. Further, a situation is hardly occurred that the terminal is displaced due to vibration or the like to be unable to be inserted into the through-hole of the case and abutted with the case and broken. Further, the structure members can be assembled automatically from one side and thereby a manufacturing cost is lowered while its assembling efficiency is improved. In addition, in a case that the motor having the above-mentioned structure is used for driving a pointer of a vehicle on-board instrument and the motor is attached to wiring holes of a printed circuit board of a vehicle on-board instrument panel, the dimension of the through-hole is not required to lower especially for stabilizing the position of the terminal in the case. Therefore, a possibility that the terminal is unable to pass the terminal hole of the case due to vibration or the like and is abutted with the case and broken can be reduced. Further, the terminal can be easily inserted into a wiring hole of a printed circuit board of a vehicle on-board instrument panel.

In the motor in accordance with at least an embodiment of the present invention, the number of the salient poles is three or more, and the number of the predetermined salient pole is two. In this case, it is preferable that the number of the salient poles is six.

In the motor in accordance with at least an embodiment of the present invention, a length in the radial direction of the predetermined salient pole is longer than lengths in the radial direction of other salient poles.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is an outward appearance perspective view showing a motor in accordance with a first embodiment of the present invention which is viewed in one direction.

FIG. 2 is an outward appearance perspective view showing the motor in accordance with the first embodiment of the present invention which is viewed in another direction.

FIG. 3 is a perspective view showing a state that a second case structuring a part of a case of the motor in accordance with the first embodiment of the present invention is detached.

FIG. 4 is an exploded perspective view showing the motor in accordance with the first embodiment of the present invention.

FIG. 5 is an explanatory top plan view showing the motor in accordance with the first embodiment of the present invention.

FIG. 6 is an explanatory side view showing the motor in accordance with the first embodiment of the present invention.

FIG. 7 is an explanatory top plan view showing the motor in accordance with the first embodiment of the present invention.

FIG. 8 is a perspective view showing a stator of the motor in accordance with the first embodiment of the present invention.

FIG. 9 is a top plan view showing the stator of the motor in accordance with the first embodiment of the present invention.

FIG. 10 is a perspective view showing a coil bobbin of the motor in accordance with the first embodiment of the present invention.

FIG. 11 is a top plan view showing a stator core of a motor in accordance with a second embodiment of the present invention.

FIG. 12 is a top plan view showing a stator of the motor in accordance with the second embodiment of the present invention.

FIG. 13 is a top plan view showing a stator core of a motor in accordance with a third embodiment of the present invention.

FIG. 14 is a perspective view showing the stator core of the motor in accordance with the third embodiment of the present invention.

FIG. 15 is a perspective view showing a coil bobbin of the motor in accordance with the third embodiment of the present invention which is viewed in one direction.

FIG. 16 is a perspective view showing the coil bobbin of the motor in accordance with the third embodiment of the present invention which is viewed in another direction.

FIG. 17 is a cross-sectional view showing a state in which coil bobbins are attached to a stator core of the motor in accordance with the third embodiment of the present invention and which is cut in a length direction of a body part of the coil bobbin.

FIG. 18 is a perspective view showing a state in which coil bobbins are attached to the stator core of the motor in accordance with the third embodiment of the present invention and which is cut in a length direction of the body part of the coil bobbin.

FIG. 19 is a perspective view showing a coil bobbin of a motor in accordance with a fourth embodiment of the present invention.

FIG. 20 is a perspective view showing a coil bobbin of a motor in accordance with a fifth embodiment of the present invention.

FIG. 21 is an explanatory view showing a first process of assembling work of the motor in accordance with at least an embodiment the present invention.

FIG. 22 is an explanatory view showing a second process of the assembling work of the motor in accordance with at least an embodiment the present invention.

FIG. 23 is an explanatory view showing a third process of the assembling work of the motor in accordance with at least an embodiment the present invention.

FIG. 24 is an explanatory view showing a fourth process of the assembling work of the motor in accordance with at least an embodiment the present invention.

FIG. 25 is an explanatory view showing a fifth process of the assembling work of the motor in accordance with at least an embodiment the present invention.

FIG. 26 is an explanatory view showing a sixth process of the assembling work of the motor in accordance with at least an embodiment the present invention.

FIG. 27 is an explanatory view showing an assembly completed state of the motor in accordance with at least an embodiment the present invention.

FIG. 28 is a perspective view showing a stator core and coil bobbins of a conventional motor.

### DETAILED DESCRIPTION OF THE PREFERRED EMBODIMENTS

Structures of motors in accordance with embodiments of the present invention will be described below with reference to the accompanying drawings.

### First Embodiment

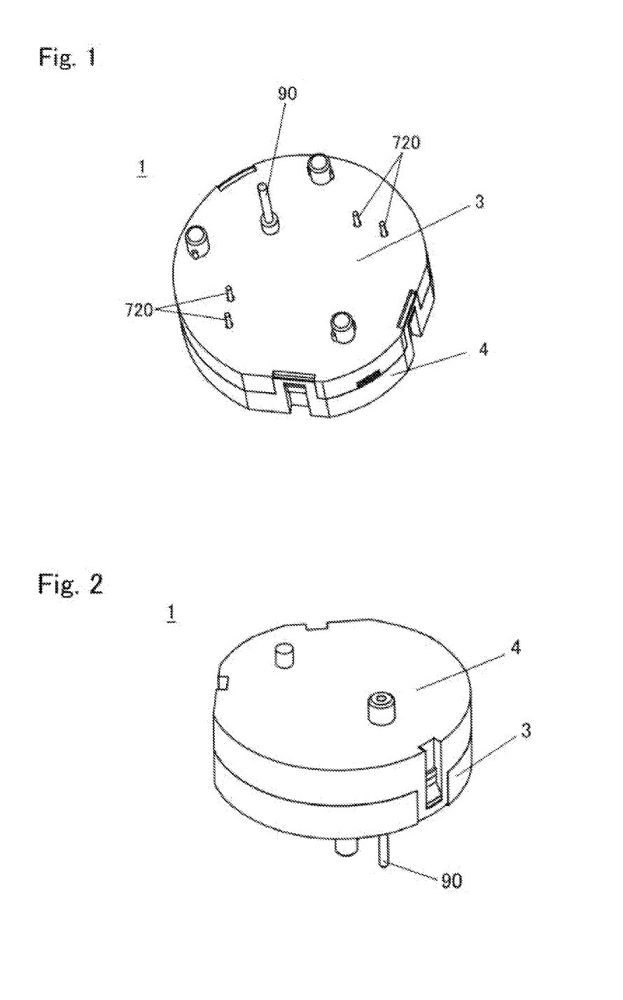

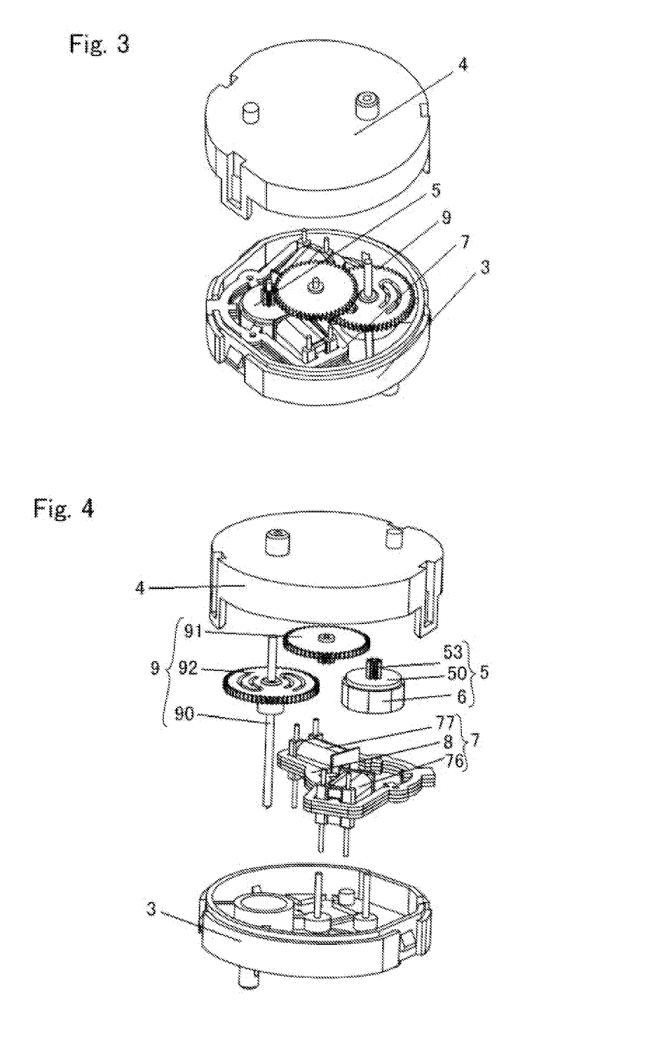

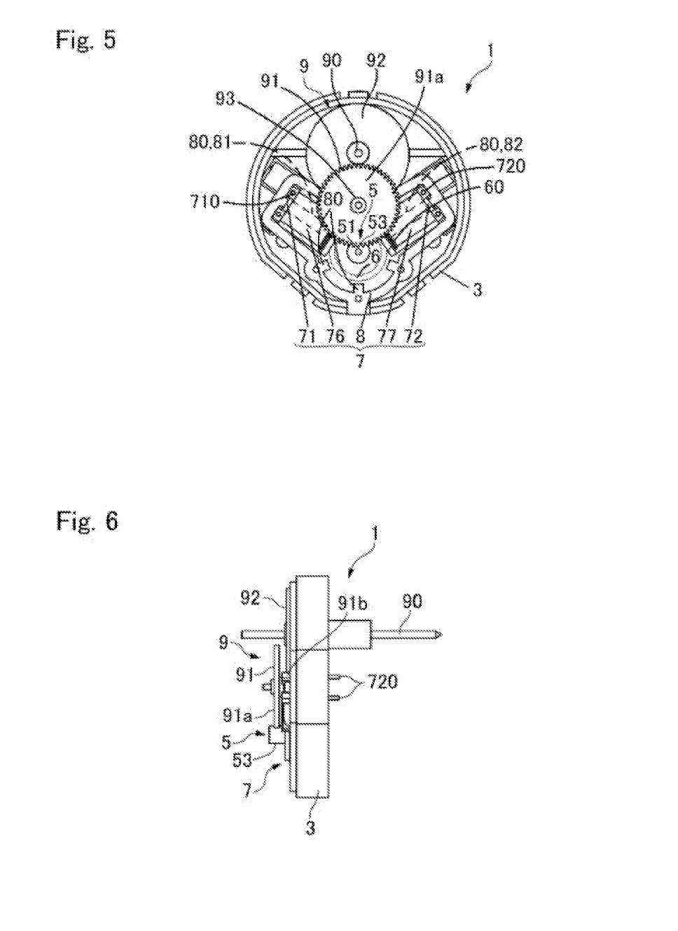

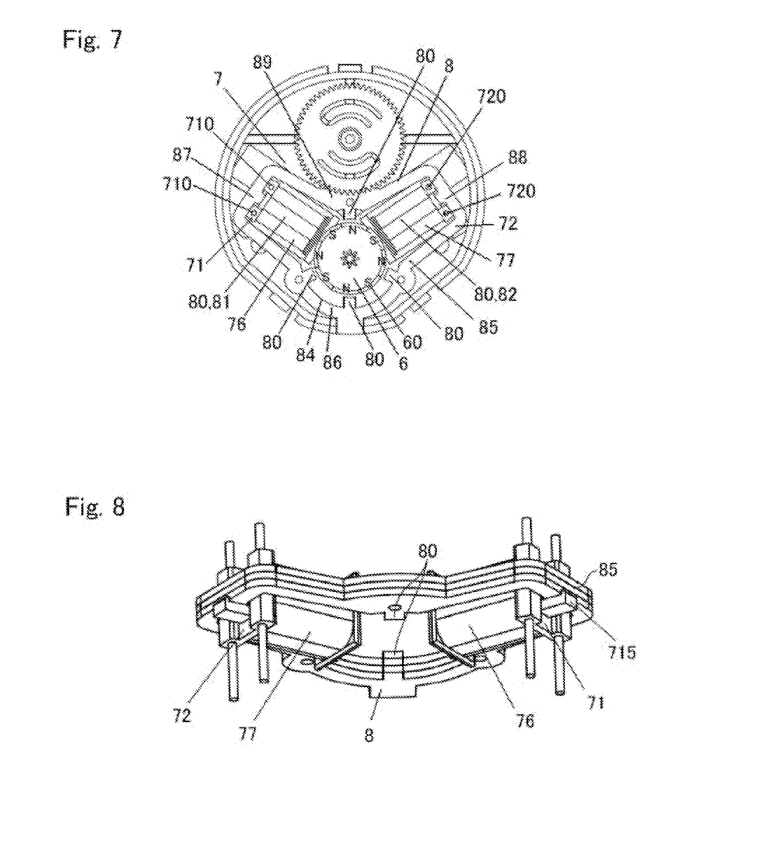

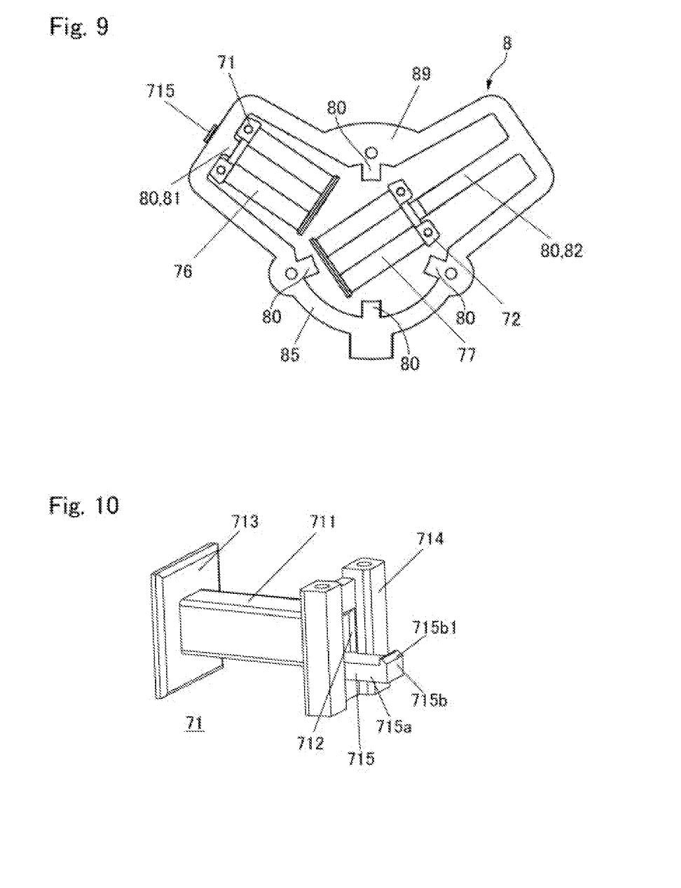

A first embodiment in accordance with the present invention will be described below with reference to FIGS. 1 through 10. FIG. 1 is an outward appearance perspective view showing a motor in accordance with the first embodiment of the present invention which is viewed in one direction (from an output shaft side of a motor). FIG. 2 is an outward appearance perspective view showing the motor in accordance with the first embodiment of the present invention which is viewed in another direction (from an opposite side to the output shaft of the motor). FIG. 3 is a perspective view showing a state that a second case structuring a part of a case of the motor in accordance with the first embodiment of the present invention is detached. FIG. 4 is an exploded perspective view showing the motor in accordance with the first embodiment of the present invention, FIG. 5 is an explanatory top plan view showing the motor in accordance with the first embodiment of the present invention, and FIG. 6 is an explanatory side view showing the motor in accordance with the first embodiment of the present invention. FIG. 7 is an explanatory top plan view showing the motor in accordance with the first embodiment of the present invention, FIG. 8 is a perspective view showing a stator of the motor in accordance with the first embodiment of the present invention, FIG. 9 is a top plan view showing the stator of the motor in accordance with the first embodiment of the present invention, and FIG. 10 is a perspective view showing a coil bobbin of the motor in accordance with the first embodiment of the present invention.

As shown in FIGS. 1 and 2, the motor 1 in this embodiment includes a case in an almost cylindrical shape which is comprised of a first case 3 and a second case 4.

As shown in FIGS. 3 and 4, the motor 1 in this embodiment includes members such as a rotor 5, a stator 7 and a reduction gear mechanism 9 which are provided in a space surrounded by the first case 3 and the second case 4.

As shown in FIGS. 5 and 6, the motor 1 in this embodiment includes the rotor 5 which is rotatably supported by the first case 3 and the stator 7 which is disposed around the rotor 5. In this embodiment, a support shaft 51 is fixed to the first case 3 and the rotor 5 is rotatably supported by the support shaft 51. Therefore, the rotor 5 is rotatably supported by the first case 3 through the support shaft 51. Further, the motor 1 includes the reduction gear mechanism 9 which decelerates and transmits rotation of the rotor 5 to an output shaft 90 and the reduction gear mechanism 9 is also supported by the first case 3 similarly to the rotor 5 and the stator 7.

The rotor 5 includes a pinion 53 which is rotatably supported by the support shaft 51 and a magnet 6 in a cylindrical shape which is integrated with the pinion 53. In this embodiment, the magnet 6 and the pinion 53 are integrated with each other by insert building. Therefore, the magnet 6 and the pinion 53 are connected with each other through a circular plate part 50 made of resin. In this embodiment, the magnet 6 is made of ferritic material.

As shown in FIGS. 5 and 7, the stator 7 includes a stator core 8 provided with a plurality of salient poles 80 which face an outer peripheral face 60 (circumferential face) of the magnet 6 through a gap space, a first coil 76 which is wound around a first salient pole 81 (predetermined salient pole) of a plurality of the salient poles 80 through a coil bobbin 71 made of resin, and a second coil 77 which is wound around a second salient pole 82 (predetermined salient pole) of a plurality of the salient poles 80 through a coil bobbin 72 made of resin. Two terminals 710 for supplying power to the first coil 76 are held in an end part of the coil bobbin 71 and two terminals 720 for supplying power to the second coil 77 are held in an end part of the coil bobbin 72. End parts of a winding start and a winding end of the first coil 76 are bound and welded to the terminals 710 and end parts of a winding start and a winding end of the second coil 77 are bound and welded to the terminals 720. As shown in FIG. 1, in an assembled state, the terminals 710 and 720 are protruded to the outside of the case through through-holes provided in the first case 3.

As shown in FIGS. 5 and 6, the reduction gear mechanism 9 includes a first gear 91 provided with a large diameter gear 91a which is engaged with the pinion 53 and a second gear 92 which is engaged with a small diameter gear 91b of the first gear 91 and has a diameter larger than that of the first gear 91. The first gear 91 is rotatably supported by a support shaft 93 and the second gear 92 is fixed to the output shaft 90.

In the motor 1 structured as described above, the motor 1 is rotated by supplying drive pulses of respective phases to the first coil 76 and the second coil 77 through the terminals 710 and 720 and the rotation of the rotor 5 is transmitted to the output shaft 90 through the reduction gear mechanism 9. Further, in a case that a pointer type display device is structured with the use of the motor 1, a pointer (not shown) is fixed to the output shaft 90. In the display device, an angular position of the pointer is changed by drive pulses supplied to the first coil 76 and the second coil 77 through the terminals 710 and 720. In this case, drive pulses for positive rotation are supplied to the terminals 710 and 720 to turn the pointer in a clockwise direction to a target position and then, when drive pulses for stopping are supplied to the terminals 710 and 720, the pointer is stopped at the target position. Further, in this state, when drive pulses for reverse rotation are supplied to the terminals 710 and 720, the pointer is turned to another target position in a counterclockwise direction.

As shown in FIG. 7, in this embodiment, the magnet 6 is alternately provided with “S”-poles and “N”-poles on an outer peripheral face 60 in a circumferential direction at equal angular intervals. In this embodiment, the magnet 6 is formed with four pairs of an “S”-pole and an “N”-pole. Therefore, the magnet 6 is formed with totaled eight poles of an “S”-pole and an “N”-pole at equal angular intervals and thus an angular position between an “S”-pole and an “N”-pole adjacent to each other in the circumferential direction is displaced from each other by 45°.

The stator core 8 is formed with an opening part 84 where the magnet 6 is disposed and a plurality of the salient poles 80 protruding toward the outer peripheral face 60 of the magnet 6 is disposed on an inner circumferential edge of the opening part 84 in a circumferential direction. An end part on an inner side in a radial direction of the salient pole 80 faces the outer peripheral face 60 of the magnet 6 through a gap space, and a dimension of the gap space between the end part on the inner side in the radial direction of the salient pole 80 and the outer peripheral face 60 of the magnet 6 is equal in each of a plurality of the salient poles 80. In this embodiment, the number of the salient poles 80 is 6 (six).

In this embodiment, dimensions in the radial direction of the first salient pole 81 and the second salient pole 82 of a plurality of the salient poles 80 are longer than those of other salient poles 80. Therefore, a dimension in the radial direction of a winding around portion of the first coil 76 around the first salient pole 81 and a dimension in the radial direction of a winding around portion of the second coil 77 around the second salient pole 82 are longer than those in the radial direction of other salient poles 80. The dimensions in the radial direction of the first salient pole 81 and the second salient pole 82 are equal to each other and the dimension in the radial direction of the winding around portion of the first coil 76 wound around the first salient pole 81 is equal to the dimension in the radial direction of the winding around portion of the second coil 77 wound around the second salient pole 82.

In the salient poles 80 other than the first salient pole 81 and the second salient pole 82 of a plurality of the salient poles 80, their dimensions in the radial direction, in other words, length dimensions of the salient poles 80 protruding from a connecting part 85 described below toward the outer peripheral face 60 of the magnet 6 are the same as each other and thus end parts on an outer side in the radial direction of the salient poles 80 other than the first salient pole 81 and the second salient pole 82 are located at the same distance position from the magnet 6. On the other hand, the dimensions in the radial direction of the first salient pole 81 and the second salient pole 82 are longer than those of other salient poles 80 and thus an end part on an outer side in the radial direction of the first salient pole 81 and an end part on an outer side in the radial direction of the second salient pole 82 are located on an outer side in the radial direction relative to the end parts on the outer side in the radial direction of other salient poles 80.

As shown in FIG. 7, the stator core 8 is provided with a connecting part 85 in a frame shape which connects the end parts on an outer side in the radial direction of all salient poles 80 including the first salient pole 81 and the second salient pole 82, and a width dimension of the connecting part 85 is approximately the same over the whole periphery. Therefore, the connecting part 85 is formed in a circular arc part 86 which is concentric with the magnet 6 except an angular range where the first salient pole 81 and the second salient pole 82 are formed. On the other hand, an angular range of the connecting part 85 where the first salient pole 81 is formed is formed in a trapezoid part 87 which is protruded to an outer side in the radial direction in a trapezoid frame shape, and an angular range where the second salient pole 82 is formed in a trapezoid part 88 which is protruded to an outer side in the radial direction in a trapezoid frame shape. Therefore, a portion between the trapezoid parts 87 and 88 is formed in a shape which is recessed to an inner side in the radial direction and a portion 89 between the trapezoid parts 87 and 88 is also formed in a circular arc shape. In this embodiment, as shown in FIG. 9, a width dimension of the circular arc part 86 and width dimensions of the trapezoid parts 87 and 88 of the connecting part 85 are the same as each other. However, a width dimension of the portion 89 between the trapezoid parts 87 and 88 is wider than the width dimension of the circular arc part 86 and the width dimensions of the trapezoid parts 87 and 88.

In this embodiment, as shown in FIG. 8, the stator core 8 is formed in a plate shape and is structured by laminating a plurality of magnetic plates which have been punched in the above-mentioned shape.

Next, specific structures of the coil bobbins 71 and 72 of the stator 7 of the motor 1 in this embodiment will be described in detail below. The structures of the coil bobbin 71 and the coil bobbin 72 are the same as each other and thus the coil bobbin 71 will be described below as an example.

As shown in FIGS. 8 through 10, the coil bobbin 71 is provided with a body part 711 around which a coil is wound and a salient pole insertion hole 712 which is formed on an inner peripheral side of the body part 711 and into which the salient pole is inserted. In this embodiment, the body part 711 of the coil bobbin 71 is provided with flange parts 713 and 714 which are located at both ends in a length direction of the body part 711 (radial direction of the stator core 8) and, in a state that the coil bobbin 71 is fitted to the stator core 8, the flange part 713 is located on an inner side in the radial direction of the stator core 8 and the flange part 714 is located on an outer side in the radial direction of the stator core 8. The flange part 714 corresponds to a terminal fixed part to which the terminal 710 is fixed.

In this embodiment, one of the coil bobbin 71 and the stator core 8 is formed with an engaging part which is engaged with the other for restraining displacement of the coil bobbin 71 to an inner side in the radial direction. In this embodiment, as described below, an engaging part comprised of an engaging pawl 715 (protruded engaging part) is formed in the coil bobbin 71. More specifically, the coil bobbin 71 is integrally formed with the engaging pawl 715 and the engaging pawl 715 is protruded from a side where the flange part 714 of the body part 711 is provided in a separated direction from the body part 711 (outer side in the radial direction) in the length direction of the body part 711. In this embodiment, as shown in FIG. 10, the engaging pawl 715 is provided with an arm part 715a which is protruded in a separated direction from the body part 711 in the length direction of the body part 711, and an engaging pawl part 715b (engaging tip end part) which is bent from a tip end of the arm part 715a in a direction perpendicular to the length direction of the body part 711. In addition, a front end face (upper end face in FIG. 10) of the engaging pawl part 715b which is located on an outer side in the radial direction is formed with an inclined face 715b1 whose normal direction is directed to a side separated from the body part 711 (outer side in the radial direction). The inclined face 715b1 of the engaging pawl part 715b faces a side where the stator core 8 is located in the axial direction of the rotor 5 shown in FIG. 4.

When the coil bobbin 71 as described above is, as shown in FIGS. 8 and 9, fitted to the first salient pole 81 from an inner side in the radial direction of the stator core 8, the connecting part 85 of the stator core 8 is interposed between the body part 711 of the coil bobbin 71 and the engaging pawl 715 and thereby the coil bobbin 71 is attached to the stator core 8. As a result, the coil bobbin 71 is restrained from being moved to an inner side in the radial direction of the stator core 8. In this manner, in this embodiment, the coil bobbin 71 attached to the stator core 8 is restrained from being moved to an inner side in the radial direction of the stator core 8. Therefore, when the motor 1 is to be assembled, a possibility is reduced that the coil bobbin 71 is protruded to an inner side in the radial direction of the stator core 8 relative to an inner side end part in the radial direction of the first salient pole 81 of the stator core 8 due to vibration or the like. Accordingly, a possibility that the magnet 6 provided in the peripheral face of the rotor 5 is abutted with the coil bobbin 71 and insertion of the rotor 5 is prevented is lowered and thus assembling efficiency of the motor 1 can be improved. Such effect and the like are similar to a case of the coil bobbin 72.

In this embodiment, the meaning of the description that “the connecting part 85 of the stator core 8 is interposed between the body part 711 of the coil bobbin 71 and the engaging pawl 715” is not limited to a structure that the connecting part 85 of the stator core 8 is sandwiched and locked between the body part 711 of the coil bobbin 71 and the engaging pawl 715 so that the coil bobbin 71 is unable to move in the radial direction of the stator core 8. A structure is also included that the connecting part 85 of the stator core 8 is interposed between the body part 711 of the coil bobbin 71 and the engaging pawl 715 so that the coil bobbin is permitted to move a little in the radial direction of the stator core 8.

### Second Embodiment

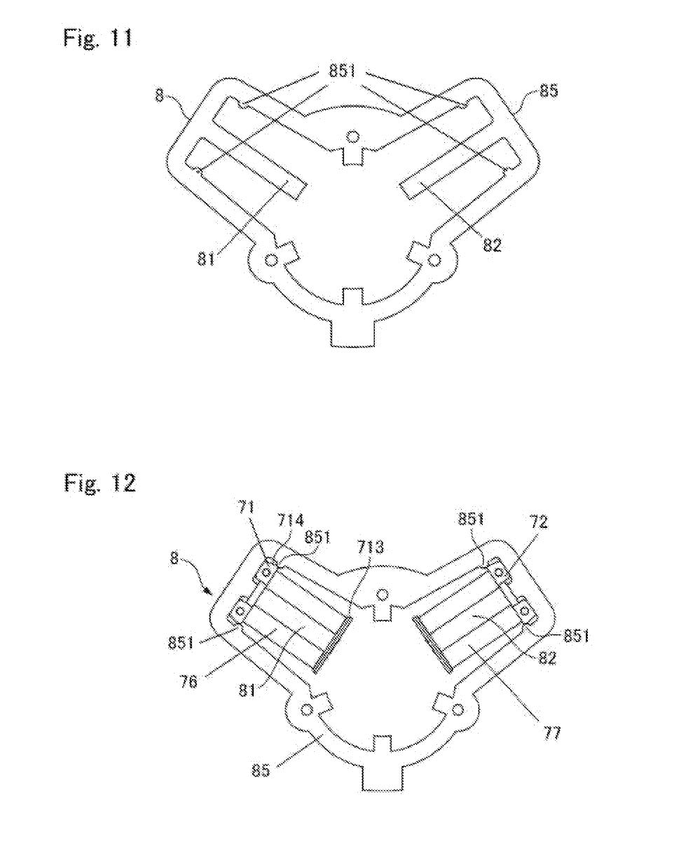

A structure of a motor in accordance with a second embodiment of the present invention is almost similar to the motor in accordance with the first embodiment but a structure of a stator core is different. Therefore, a different structure will be mainly described below with reference to FIGS. 11 and 12. FIG. 11 is a top plan view showing a stator core of a motor in accordance with a second embodiment of the present invention. FIG. 12 is a top plan view showing a stator of the motor in accordance with the second embodiment of the present invention.

In the second embodiment, as described below, the flange part 714 of the coil bobbin 71 is interposed and sandwiched between a portion of the connecting part 85 of the stator core 8 which is located on a side with respect to the first salient pole 81 and a portion of the connecting part 85 which is located on an outer side in the radial direction relative to the flange part 714. Further, a first protruded part 851 is formed at a portion of the connecting part 85 located on the side with respect to the first salient pole 81 and the first protruded part 851 is formed as an engaging part for sandwiching the flange part 714 from an inner side in the radial direction together with the portion of the connecting part 85 located on the outer side in the radial direction relative to the flange part 714. Further, the flange part 714 is locked between the portion of the connecting part 85 located on the outer side in the radial direction relative to the flange part 714 and the first protruded part 851 in the radial direction, and the flange part 714 is set in a state so as to be unable to move in the radial direction.

More specifically, as shown in FIG. 11, the first protruded parts 851 protruding to inner sides are formed in a symmetrical manner on an inner peripheral edge of the connecting part 85 of the stator core 8 so as to interpose the first salient pole 81 therebetween, and first protruded parts 851 protruding to inner sides are formed in a symmetrical manner on an inner peripheral edge of the connecting part 85 of the stator core 8 so as to interpose the second salient pole 82 therebetween. Therefore, as shown in FIG. 12, in a state that the coil bobbin 71 has been attached to the first salient pole 81 of the stator core 8, the flange part 714 of the coil bobbin 71 on the outer side in the radial direction with respect to the stator core 8 is sandwiched between the connecting part 85 and the first protruded parts 851 of the stator core 8.

According to the second embodiment, in a state that the coil bobbin 71 has been attached to the stator core 8, similarly to the first embodiment, the flange part 714 of the coil bobbin 71 on the outer side in the radial direction with respect to the stator core 8 is sandwiched between the connecting part 85 and the first protruded parts 851 provided in the connecting part 85, which is different from a case that the connecting part 85 of the stator core 8 is interposed between the body part 711 of the coil bobbin 71 and the engaging pawl 715 (see FIGS. 8 through 10). Therefore, in comparison with the first embodiment, the coil bobbin 71 attached to the stator core 8 is restrained from moving to an inner side in the radial direction with respect to the stator core 8. Accordingly, when the motor 1 is to be assembled, a possibility that the coil bobbin 71 is protruded to an inner side in the radial direction relative to the inner side end part of the first salient pole 81 of the stator core 8 due to vibration or the like can be reduced. As a result, a possibility that the magnet 6 provided in the peripheral face of the rotor 5 is abutted with the coil bobbins 71 and 72 and insertion of the rotor 5 is prevented is lowered and thus assembling efficiency of the motor 1 can be improved. Such effect and the like are similar to a case of the coil bobbin 72.

In this embodiment, the meaning of the description that “the flange part 714 of the coil bobbin 71 located on an outer side in the radial direction with respect to the stator core 8 is interposed and sandwiched between the connecting part 85 and the first protruded part 851 provided in the connecting part 85” is not limited to a structure that the flange part 714 of the coil bobbin 71 located on an outer side in the radial direction with respect to the stator core 8 is locked between the connecting part 85 and the first protruded part 851 provided in the connecting part 85 so that the coil bobbin 71 is unable to move in the radial direction with respect to the stator core 8. A structure is also included that the flange part 714 of the coil bobbin 71 located on an outer side in the radial direction with respect to the stator core 8 is interposed between the connecting part 85 and the first protruded part 851 provided in the connecting part 85 so that the coil bobbin 71 can be moved a little in the radial direction with respect to the stator core 8.

### Third Embodiment

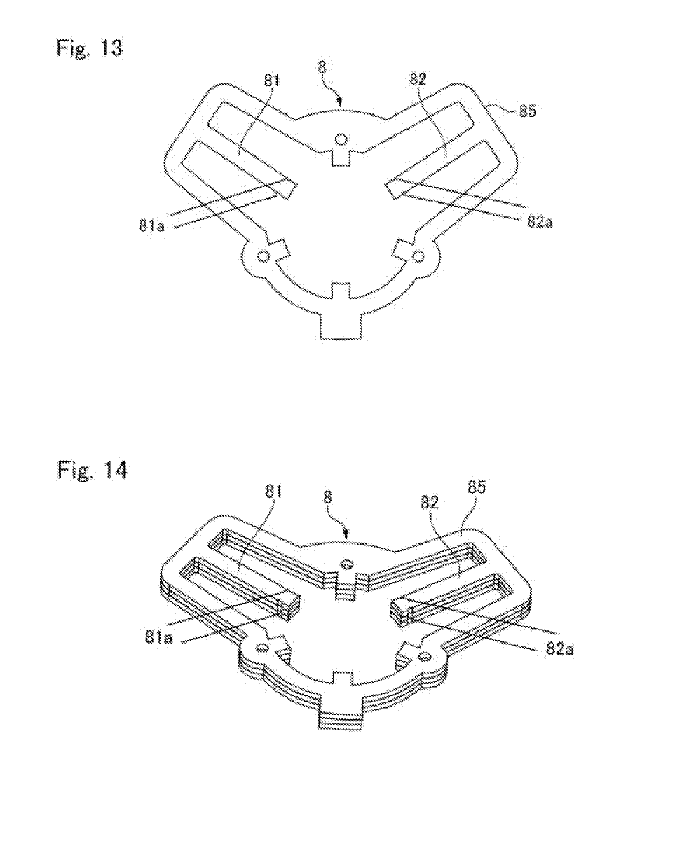

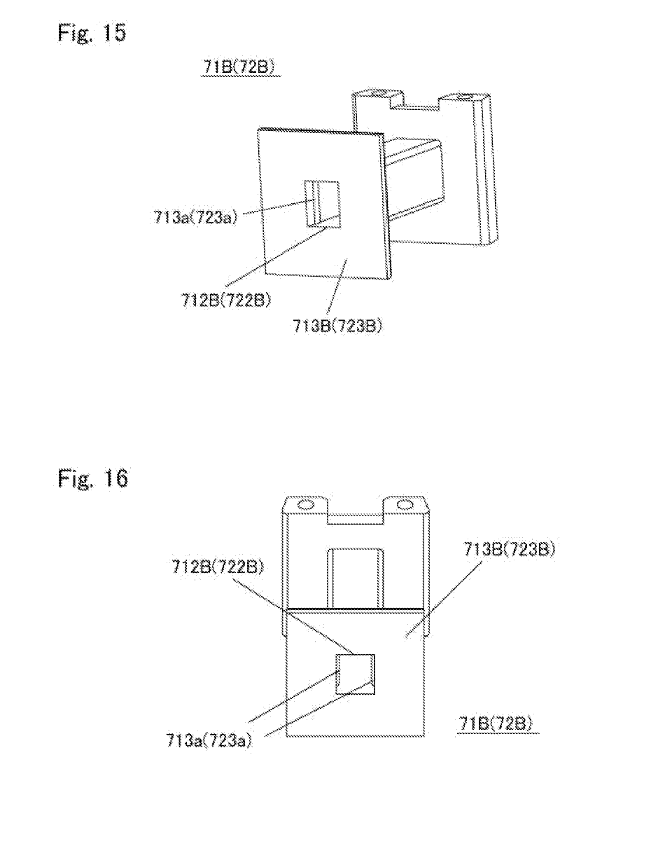

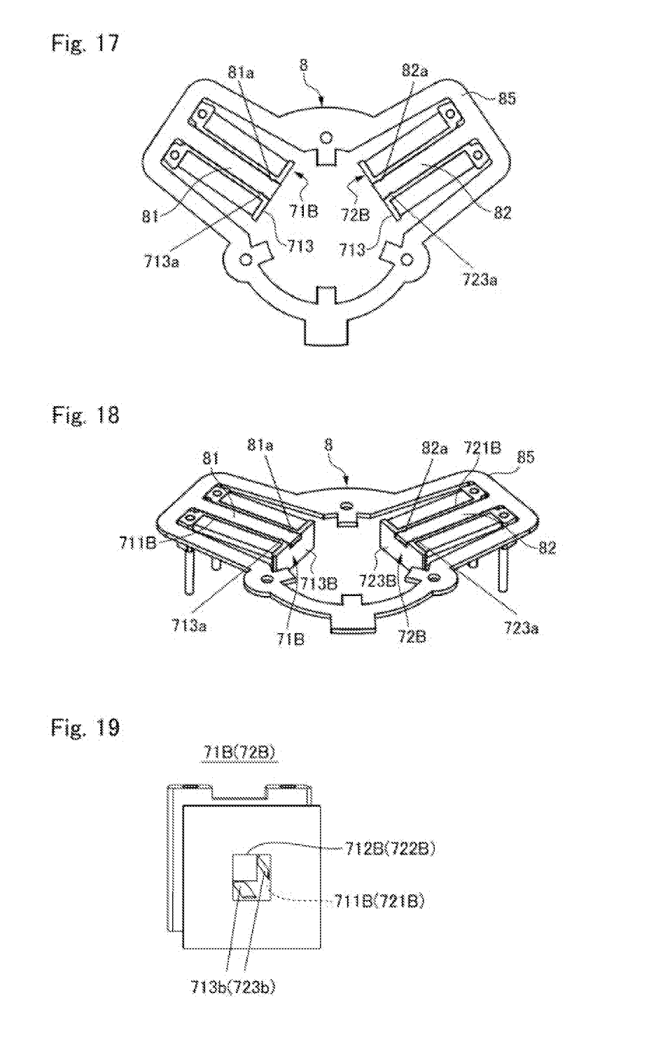

A structure of a motor in accordance with a third embodiment of the present invention is almost similar to the motors in accordance with the first embodiment and the second embodiment but structures of a stator core and a coil bobbin are different. Therefore, different structures will be mainly described below with reference to FIGS. 13 through 18. FIG. 13 is a top plan view showing a stator core of a motor in accordance with a third embodiment of the present invention, and FIG. 14 is a perspective view showing the stator core of the motor in accordance with the third embodiment of the present invention. FIG. 15 is a perspective view showing a coil bobbin of the motor in accordance with the third embodiment of the present invention which is viewed in one direction, and FIG. 16 is a perspective view showing the coil bobbin of the motor in accordance with the third embodiment of the present invention which is viewed in another direction. FIG. 17 is a cross-sectional view showing a state in which coil bobbins are attached to a stator core of the motor in accordance with the third embodiment of the present invention and which is cut in a length direction of a body part of the coil bobbin (in other words, in an attaching direction when the coil bobbin is attached to the salient pole of the stator core). FIG. 18 is a perspective view showing a state in which the coil bobbins are attached to the stator core of the motor in accordance with the third embodiment of the present invention and which is cut in the length direction of the body part of the coil bobbin.

In the third embodiment, as shown in FIGS. 13 and 14, recessed parts 81a and 82a which are extended in a thickness direction of the stator core 8 are respectively provided at near positions (near position to the magnet 6) to end parts on an inner side in the radial direction of the first salient pole 81 and the second salient pole 82 of the stator core 8. More specifically, two recessed parts 81a are symmetrically formed on the first salient pole 81 on both sides in a circumferential direction of the stator core 8 and two recessed parts 82a are symmetrically formed on the second salient pole 82 on both sides in the circumferential direction of the stator core 8.

In this embodiment, as shown in FIGS. 15 through 18, second protruded parts 713a and 723a which are extended in the thickness direction of the stator core 8 are respectively formed on salient pole insertion holes 712B and 722B of the coil bobbins 71B and 72B at near positions to the flange parts 713B and 723B (near position to the magnet 6) so as to correspond to the recessed parts 81a and 82a. Specifically, two second protruded parts 713a are symmetrically formed on inner wall faces of the salient pole insertion hole 712B on both sides in the circumferential direction of the stator core 8, and two second protruded parts 723a are symmetrically formed on inner wall faces of the salient pole insertion hole 722B on both sides in the circumferential direction of the stator core.

According to the third embodiment, in a state that the coil bobbins 71B and 72B have been attached to the stator core 8, the second protruded parts 713a and 723a formed on the salient pole insertion holes 712B and 722B of the coil bobbins 71B and 72B at the near positions to the flange parts 713B and 723B are fitted to the recessed parts 81a and 82a provided on the first salient pole 81 and the second salient pole 82 of the stator core 8 at the near positions to their end parts on the inner side in the radial direction, which is different from a case that, similarly to the first embodiment, the connecting part 85 of the stator core 8 is interposed between the body parts 711B and 721B of the coil bobbins 71B and 72B and engaging pawls (see FIGS. 8 through 10). Therefore, in comparison with the first embodiment, the coil bobbins 71B and 72B attached to the stator core 8 are restrained from moving to an inner side in the radial direction of the stator core 8. Accordingly, when the motor 1 is to be assembled, a possibility can be reduced that the coil bobbins 71B and 72B are protruded to an inner side in the radial direction relative to the inner side end parts of the first salient pole 81 and the second salient pole 82 of the stator core 8 due to vibration or the like. As a result, a possibility that the magnet 6 provided in the peripheral face of the rotor 5 is abutted with the coil bobbins 71B and 72B and insertion of the rotor 5 is prevented is lowered and thus assembling efficiency of the motor 1 can be improved.

### Fourth Embodiment

A structure of a motor in accordance with a fourth embodiment of the present invention is almost similar to the motors in accordance with the first through the third embodiments but a structure of a coil bobbin is different. Therefore, a different structure will be mainly described below with reference to FIG. 19. FIG. 19 is a perspective view showing a coil bobbin of a motor in accordance with a fourth embodiment of the present invention. In the third embodiment, an engaging part which restrains moving of the coil bobbins 71B and 72B to an inner side in the radial direction is structured by the recessed parts 81a and 82a of the stator core 8 and the second protruded parts 713a and 723a of the coil bobbins 71B and 72B. However, in the fourth embodiment, an engaging part which restrains moving of the coil bobbins 71B and 72B to an inner side in the radial direction is structured of second protruded parts 713b and 723b formed in the coil bobbins 71B and 72B.

More specifically, as shown in FIG. 19, a plurality of the second protruded parts 713b and 723b extended in length directions (radial direction) of the body parts 711B and 721B of the coil bobbins 71B and 72B are formed on a plurality of inner wall faces of the salient pole insertion holes 712B and 722B of the coil bobbins 71B and 72B, and the second protruded parts 713b and 723b are laterally provided over an almost entire length range of the body parts 711B and 721B of the coil bobbins 71B and 72B.

According to the fourth embodiment, in a state that the coil bobbins 71B and 72B have been attached to the stator core 8, the second protruded parts 713b and 723b which are formed on the inner wall faces of the salient pole insertion holes 712B and 722B of the coil bobbins 71B and 72B and the outer peripheral faces of the first salient pole 81 and the second salient pole 82 of the stator core 8 are engaged with each other or press-fitted to each other, which is different from a case that, similarly to the first embodiment, the connecting part 85 of the stator core 8 is interposed between the body parts 711B and 721B of the coil bobbins 71B and 72B and engaging pawls (see FIGS. 8 through 10). Therefore, in comparison with the first embodiment, the coil bobbins 71B and 72B attached to the stator core 8 are restrained from moving to an inner side in the radial direction of the stator core 8. Accordingly, when the motor 1 is to be assembled, a possibility can be reduced that the coil bobbins 71B and 72B are protruded to an inner side in the radial direction relative to the inner side end parts of the first salient pole 81 and the second salient pole 82 of the stator core 8 due to vibration or the like. As a result, a possibility that the magnet 6 provided in the peripheral face of the rotor 5 is abutted with the coil bobbins 71B and 72B and insertion of the rotor 5 is prevented is lowered and thus assembling efficiency of the motor 1 can be improved.

### Fifth Embodiment

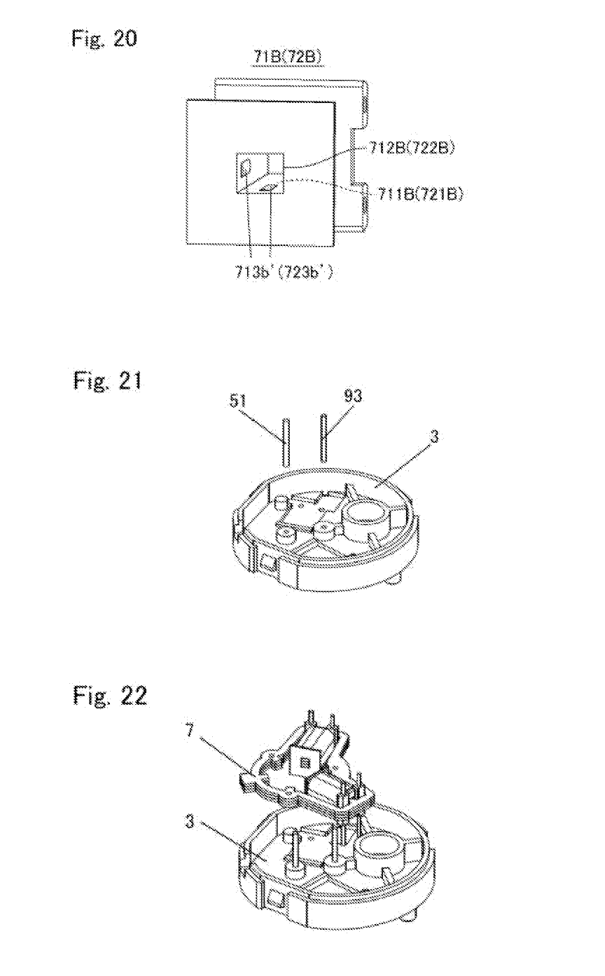

A structure of a motor in accordance with a fifth embodiment of the present invention is almost similar to the motor in accordance with the fourth embodiment but a structure of a coil bobbin is different. Therefore, a different structure will be mainly described below with reference to FIG. 20. FIG. 20 is a perspective view showing a coil bobbin of a motor in accordance with the fifth embodiment of the present invention.

Similarly to the fourth embodiment, as shown in FIG. 20, a plurality of second protruded parts 713b′ and 723b′ extended in length directions of the body parts 711B and 721B of the coil bobbins 71B and 72B are formed on a plurality of inner wall faces of the salient pole insertion holes 712B and 722B of the coil bobbins 71B and 72B. However, different from the fourth embodiment, in the fifth embodiment, dimensions of the second protruded parts 713b′ and 723b′ in the length directions of the body parts 711B and 721B of the coil bobbins 71B and 72B are considerably smaller than the lengths of the body parts 711B and 721B of the coil bobbins 71B and 72B.

According to the fifth embodiment, in a state that the coil bobbins 71B and 72B have been attached to the stator core 8, the second protruded parts 713b′ and 723b′ which are formed on the inner wall faces of the salient pole insertion holes 712B and 722B of the coil bobbins 71B and 72B and the outer peripheral faces of the first salient pole 81 and the second salient pole 82 of the stator core 8 are engaged with each other or press-fitted to each other, which is different from a case that, similarly to the first embodiment, the connecting part 85 of the stator core 8 is interposed between the body parts 711B and 721B of the coil bobbins 71B and 72B and engaging pawls (see FIGS. 8 through 10). Therefore, in comparison with the first embodiment, the coil bobbins 71B and 72B attached to the stator core 8 are restrained from moving to an inner side in the radial direction of the stator core 8. Accordingly, when the motor 1 is to be assembled, a possibility can be reduced that the coil bobbins 71B and 72B are protruded to an inner side in the radial direction relative to the inner side end parts of the first salient pole 81 and the second salient pole 82 of the stator core 8 due to vibration or the like. As a result, a possibility that the magnet 6 provided in the peripheral face of the rotor 5 is abutted with the coil bobbins 71B and 72B and insertion of the rotor 5 is prevented is lowered and thus assembling efficiency of the motor 1 can be improved.

### [Assembling Work of Motor 1]

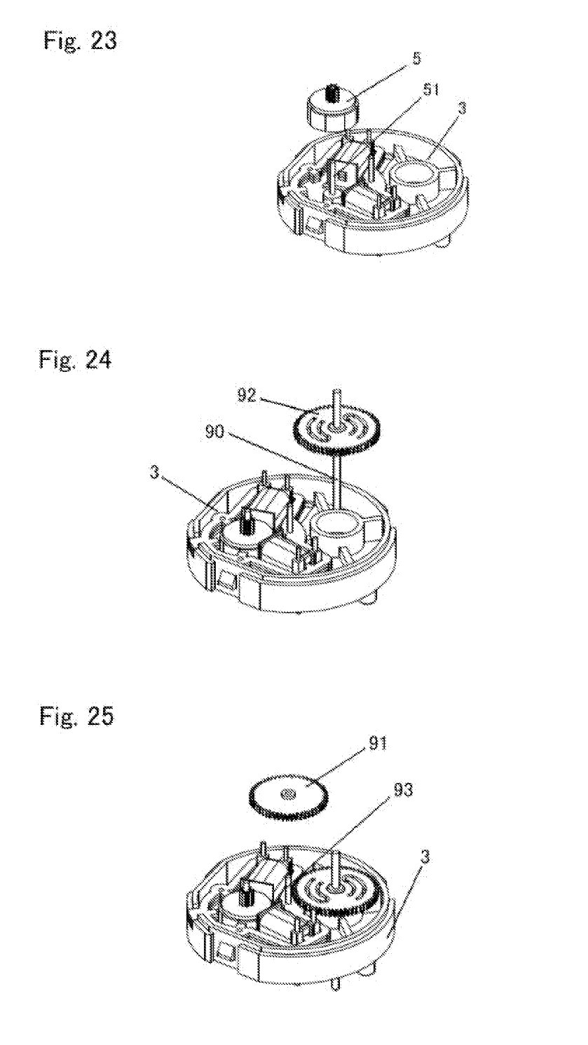

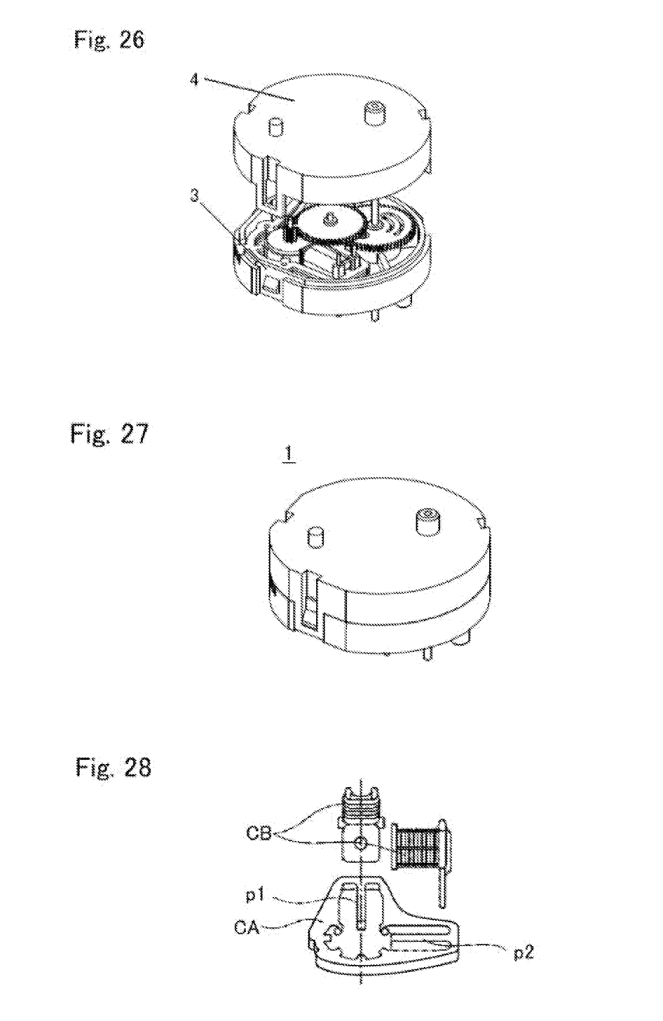

Assembling work of the motor in accordance with an embodiment of the present invention will be briefly described below with reference to the accompanying drawings. FIG. 21 is an explanatory view showing a first process of assembling work of the motor in accordance with at least an embodiment of the present invention and FIG. 22 is an explanatory view showing a second process of the assembling work of the motor in accordance with at least an embodiment of the present invention. FIG. 23 is an explanatory view showing a third process of the assembling work of the motor in accordance with at least an embodiment of the present invention and FIG. 24 is an explanatory view showing a fourth process of the assembling work of the motor in accordance with at least an embodiment of the present invention. FIG. 25 is an explanatory view showing a fifth process of the assembling work of the motor in accordance with at least an embodiment of the present invention, FIG. 26 is an explanatory view showing a sixth process of the assembling work of the motor in accordance with at least an embodiment of the present invention, and FIG. 27 is an explanatory view showing an assembly completed state of the motor in accordance with at least an embodiment of the present invention.

When the motor 1 is to be assembled, first, as shown in FIG. 21, a support shaft 51 for a rotor and a support shaft 93 for the first gear are inserted into support shaft support holes formed in the first case 3. After that, as shown in FIG. 22, the stator 7 in which the coil bobbins are attached to the stator core is assembled in the first case 3. Next, as shown in FIG. 23, the rotor 5 is attached to the support shaft 51 and, as shown in FIG. 24, the second gear 92 fixed to the output shaft 90 is assembled in the first case 3 and, further, as shown in FIG. 25, the first gear 91 is attached to the support shaft 93. Finally, as shown in FIG. 26, the second case 4 is attached to the first case 3 to structure the motor 1 in an assembly completed state as shown in FIG. 27.

### OTHER EMBODIMENTS

Although the present invention has been shown and described with reference to specific embodiments, various changes and modifications will be apparent to those skilled in the art from the teachings herein.

For example, in the above-mentioned first through fifth embodiments, the coil bobbins 71 and 72 are made of resin. However, the present invention is not limited to resin and other materials may be adopted corresponding to actual demands. In this case, when the coil bobbins 71 and 72 are made of resin, its manufacturing cost can be reduced and the coil bobbin having the engaging pawl in its tip end can be attached to the stator core and engaged with the connecting part of the stator core by utilizing the elasticity of the coil bobbin.

In the above-mentioned first through fifth embodiments, the stator core 8 is formed with two salient poles, in other words, the first salient pole 81 and the second salient pole 82, whose dimensions in the radial direction are different from other salient poles 80 and to which the coil bobbins 71 and 72 are attached. However, the present invention is not limited to this structure. At least an embodiment of the present invention may be applied to a case that the stator core 8 is formed with only one salient pole whose dimension in the radial direction are different from other salient poles and to which the coil bobbin is attached, or may be applied to a case that the stator core 8 is formed with three, or four or more salient poles whose dimensions in the radial direction are different from other salient poles and to which the coil bobbins are attached. Further, all the dimensions in the radial direction of the respective salient poles may be set the same as each other corresponding to actual demands. In addition, the number of the salient poles 80 of the stator core 8 is not limited to the above-mentioned embodiments, and the salient poles to which the coil bobbin is attached are not limited to the first salient pole and the second salient pole.

In the above-mentioned first through fifth embodiments, the body part 711 of the coil bobbin 71 is provided with the flange part 713 and the flange part 714 which are located at both ends in the length direction of the body part 711. However, the present invention is not limited to the embodiments and, in the first through the fifth embodiments, one of the flange part 713 and the flange part 714 may be omitted and, in addition, both of the flange part 713 and the flange part 714 may be omitted.

Further, in the above-mentioned first embodiment, the engaging pawl part 715b is bent from a tip end of the arm part 715a in a direction perpendicular to the length direction of the body part 711. However, the present invention is not limited to this embodiment and the engaging pawl part 715 may be bent from the arm part 715a in a direction perpendicular to the length direction of the body part 711. In addition, in the first embodiment, the inclined face 715b1 is formed in the front end face of the engaging pawl part 715b. However, the present invention is not limited to this embodiment and no inclined face 715b1 may be formed in the front end face of the engaging pawl part 715b.

In addition, in the above-mentioned second through fifth embodiments, similarly to the first embodiment, the connecting part 85 of the stator core 8 is interposed between the body part 711 of the coil bobbin and the engaging pawl 715. However, the present invention is not limited to this embodiment and, in the second through the fifth embodiments, the engaging pawl 715 may be omitted. Further, structures disclosed in the second through the fifth embodiments may be combined with each other when they are not conflicted with each other.

In the above-mentioned second through fifth embodiments, the numbers of the first protruded part 851 and the second protruded parts 713a, 713b and 713b′ are selected depending on actual situations and, for example, in the fourth and the fifth embodiments, the second protruded parts 713a, 713b and 713b′ are formed on a plurality of the inner wall faces of the salient pole insertion hole 712B of the coil bobbin 71B. However, the present invention is not limited to these embodiments and the second protruded parts 713a, 713b and 713b′ may be formed only on one inner wall face, or two or more second protruded parts 713a, 713b and 713b′ may be formed on each of the inner wall faces.

In the above-mentioned second embodiment, the first protruded parts 851 protruding to inner sides are symmetrically formed on an inner peripheral edge of the connecting part 85 of the stator core 8 over the first salient pole 81, and the first protruded parts 851 protruding to inner sides are symmetrically formed on an inner peripheral edge of the connecting part 85 of the stator core 8 over the second salient pole 82. However, the present invention is not limited to this embodiment and the first protruded part 851 may be asymmetrically formed on an inner peripheral edge of the connecting part 85 of the stator core 8 over the first salient pole 81 or the second salient pole 82. Further, in the second embodiment, one of the two first protruded parts 851 symmetrically formed over the first salient pole 81 and the second salient pole 82 may be omitted.

In the above-mentioned second embodiment, the flange part on an outer side in the radial direction of the coil bobbin 71 is sandwiched between the first protruded parts 851 and a portion of the connecting part 85 located on an outer side in the radial direction relative to the flange part. However, the present invention is not limited to this embodiment and a protruded part protruding to an inner side in a circumferential direction with respect to the flange part 713 on an inner side in the radial direction of the coil bobbin 71 may be formed at a position of the connecting part 85 on an inner side in the radial direction relative to the flange part 713 located on an inner side in the radial direction of the coil bobbin 71. In this case, the coil bobbin 71 is restrained from moving to an inner side in the radial direction by the protruded part.

In the above-mentioned third embodiment, two recessed parts 81a are formed symmetrically on outer peripheral faces on both sides of the first salient pole 81 in the circumferential direction of the stator core 8 and two recessed parts 82a are formed symmetrically on outer peripheral faces on both sides of the second salient pole 82 in the circumferential direction of the stator core 8. On the other hand, two second protruded parts 713a are formed symmetrically on the inner wall faces on both sides of the salient pole insertion hole 712B in the circumferential direction of the stator core 8, and two second protruded parts 723a are formed symmetrically on the inner wall faces on both sides of the salient pole insertion hole 722B in the circumferential direction of the stator core 8. However, the present invention is not limited to this embodiment. A protruded part may be formed on outer peripheral faces of the first salient pole 81 and the second salient pole 82 and a recessed part may be formed on inner wall faces of the salient pole insertion holes 712B and 722B.

In the above-mentioned third embodiment, two recessed parts 81a are formed symmetrically on outer peripheral faces on both sides of the first salient pole 81 in the circumferential direction of the stator core 8 and two recessed parts 82a are formed symmetrically on outer peripheral faces on both sides of the second salient pole 82 in the circumferential direction of the stator core 8. On the other hand, two second protruded parts 713a are formed symmetrically on the inner wall faces on both sides of the salient pole insertion hole 712B in the circumferential direction of the stator core 8, and two second protruded parts 723a are formed symmetrically on the inner wall faces on both sides of the salient pole insertion hole 722B in the circumferential direction of the stator core 8. However, the present invention is not limited to this embodiment. The two recessed parts 81a or the two recessed parts 82a may be arranged asymmetrically in the third embodiment, or one of the two recessed parts 81a and one of the two recessed parts 81a may be omitted. Further, it may be structured that the second protruded part is formed only on the inner wall faces of the salient pole insertion holes 712B and 722B, and that no recessed part is formed on the first salient pole 81 and the second salient pole 82. Further, forming positions of the recessed parts 81a and 82a and the second protruded parts 713a and 723a are not limited to the outer peripheral faces on both sides of the first salient pole 81 in the circumferential direction of the stator core 8 and the inner wall faces on both sides of the salient pole insertion holes 712B and 722B in the circumferential direction of the stator core 8.

In the above-mentioned fourth and fifth embodiments, the second protruded parts 713b′ and 723b′ which are formed on the inner wall faces of the salient pole insertion holes 712B and 722B of the coil bobbins 71B and 72B are continuously extended in the length directions of the body parts 711B and 721B of the coil bobbins 71 and 72. However, the present invention is not limited to this embodiment. A plurality of the second protruded parts 713b′ and 723b′ may be formed in a separated manner in the length direction of the body part 711 of the coil bobbin.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A motor comprising:
a rotor comprising a magnet whose peripheral face is alternately magnetized in an “S”-pole and an “N”-pole in a circumferential direction; and
a stator comprising a stator core and a coil;
wherein the stator core is provided with a plurality of salient poles, including a predetermined salient pole, which are separately formed in the circumferential direction, the plurality of the salient poles being protruded to an inner side in a radial direction and facing the peripheral face of the magnet through a gap space, the predetermined salient pole being wound around with the coil through a coil bobbin;
wherein the stator core is provided with a connecting part which connects end parts on an outer side in the radial direction of the plurality of the salient poles;
wherein the coil bobbin is provided with a body part around which the coil is wound and a salient pole insertion hole which is formed in the body part and into which the predetermined salient pole is inserted; and
wherein one of the coil bobbin and the stator core is formed with an engaging part which is engaged with another of the coil bobbin and the stator core to restrain displacement of the coil bobbin to the inner side in the radial direction.

2. The motor according to claim 1, wherein
the engaging part includes a protruded engaging part which is formed in the coil bobbin, and
the protruded engaging part is protruded to the outer side in the radial direction relative to the body part of the coil bobbin to engage with the connecting part of the stator core.

3. The motor according to claim 2, wherein the connecting part is locked between the protruded engaging part and the body part.

4. The motor according to claim 2, wherein
the coil bobbin is provided with a flange part on the outer side in the radial direction of the body part, and
the protruded engaging part is protruded from the flange part to the outer side in the radial direction to engage with the connecting part of the stator core.

5. The motor according to claim 4, wherein the connecting part is locked between the protruded engaging part and the flange part.

6. The motor according to claim 2, wherein the protruded engaging part is provided with an arm part, which protrudes to the outer side in the radial direction relative to the body part, and an engaging tip end part which is bent toward a connecting part side from a tip end of the arm part to engage with the connecting part.

7. The motor according to claim 6, wherein
an outer side face of the engaging tip end part in the radial direction is formed as an inclined face which is inclined with respect to the radial direction, and
the inclined face is directed to a side where the stator core is located in an axial direction of the rotor.

8. The motor according to claim 1, wherein
the coil bobbin is provided with a flange part on the outer side in the radial direction of the body part, and
the flange part is interposed between a portion of the connecting part located on a side with respect to the predetermined salient pole in the circumferential direction and a portion of the connecting part located on the outer side in the radial direction of the flange part.

9. The motor according to claim 4, wherein
the engaging part comprises a first protruded part formed on a portion of the connecting part located on a side with respect to the predetermined salient pole in the circumferential direction, and
the flange part is interposed between a portion of the connecting part located on the outer side in the radial direction relative to the flange part and the first protruded part.

10. The motor according to claim 9, wherein the flange part is locked between the portion of the connecting part located on the outer side in the radial direction relative to the flange part and the first protruded part.

11. The motor according to claim 1, wherein
the engaging part comprises a second protruded part which is formed on one of an outer peripheral face of the predetermined salient pole and an inner wall face of a salient pole insertion hole of the body part, and
the second protruded part is engaged with another of the outer peripheral face of the predetermined salient pole and the inner wall face of the salient pole insertion hole of the body part.

12. The motor according to claim 11, wherein the second protruded part is formed at a position which is near to the magnet.

13. The motor according to claim 11, wherein the second protruded part is extended along the radial direction.

14. The motor according to claim 11, wherein the engaging part comprises a recessed part which is formed on the other of the outer peripheral face of the predetermined salient pole and the inner wall face of the salient pole insertion hole to engage with the second protruded part.

15. The motor according to claim 14, wherein
the inner wall face of the salient pole insertion hole is formed with the second protruded part, and
the outer peripheral face of the predetermined salient pole is formed with the recessed part.

16. The motor according to claim 14, wherein the second protruded part and the recessed part are formed at a position which is near to the magnet.

17. The motor according to claim 14, wherein the second protruded part and the recessed part are extended along the radial direction.

18. The motor according to claim 17, wherein the second protruded part and the recessed part are formed so as to extend continuously along the radial direction or formed at plural positions in the radial direction in a separated manner.

19. The motor according to claim 1, wherein
the coil bobbin is formed with a terminal fixed part to which a terminal is fixed, and
an end part of a winding of the coil is wound around the terminal.

20. The motor according to claim 19, further comprising a case,
wherein the rotor and the stator are accommodated in the case, and
wherein the terminal is protruded to an outside of the case through a through hole provided in the case.

21. The motor according to claim 1, wherein
a number of the salient poles is three or more, and
a number of the predetermined salient pole is two.

22. The motor according to claim 21, wherein the number of the salient poles is six.

23. The motor according to claim 1, wherein a length in the radial direction of the predetermined salient pole is longer than lengths in the radial direction of other salient poles.
